(19) United States
(12) Patent Application Publication
(10) Pub. No.: US 2018/0116126 A1
(43) Pub. Date: May 3, 2018

(54) Cutting tool employing a rotatable circular disc, with a sharp beveled edge, that engages with an opposing jaw for the purpose of cutting; and an optional self-sharpening mechanism.

(71) Applicant: Donald Levert Andrews, Fort Myers, FL (US)

(72) Inventor: Donald Levert Andrews, Fort Myers, FL (US)

(21) Appl. No.: 15/798,845

(22) Filed: Oct. 31, 2017

Related U.S. Application Data
(60) Provisional application No. 62/414,891, filed on Oct. 31, 2016.

(51) Int. Cl. A01G 3/02; A01G 3/025

(52) U.S. Cl. CPC A01G 3/021; A01G 3/025

(57) ABSTRACT

A cutting tool such as garden shears, secateurs, toppers, scissors, tin snips, cutting pliers, and the like that employs a circular disc with a sharp, beveled edge. During the cutting process, the disc engages with an opposing jaw. Furthermore, in the cutting process, the disc is forced to rotate by a ratchet mechanism or other means. The circular disc can be easily sharpened by mounting it on a rotatable shaft. The beveled edge is then engaged with a sharpening stone or file as the disc rotates. Optionally, the tool can include a built-in, self-sharpening mechanism. Here, an abrasive sharpening element is constantly engaged with the beveled edge of the disc. Thus the disc is continually sharpened as the tool is used, and never needs to be sharpened manually.

### CROSS REFERENCE

This application claims the benefit of PPA 62/414,891.

### BACKGROUND/PRIOR ART

Many cutting tools have been proposed that employ two jaws, at least one of which is sharpened. These jaws may be attached to handles, compound levers, gear mechanisms, and the like. All such tools become dull as they are used, and therefore need to be sharpened. Many of the tools used for pruning have a sharp, convex edge. This edge engages with an opposing jaw in the cutting process. Curved edges are difficult to sharpen with files or sharpening stones. The tool in U.S. Pat No. 2,567,051 by S. Brookes is a slight improvement over the prior art. It uses a cutting disc which engages with an opposing jaw. As the disc becomes dull, the operator can remove it from the tool, rotate it 180 degrees, and reinstall it on the tool. This effectively doubles the amount of time that the tool could be used before it would need to be sharpened. However, this procedure requires the operator to stop working and reposition the disc. Furthermore, there are substantial portions of the disc that are never used.

### DRAWINGS—FIGURES

FIG. 1 is a top view of the embodiment of my tool with short handles.

FIG. 1A is a top view of the disc member upon which the disc is mounted.

FIG. 1B is a top view of the jaw member.

FIG. 2 is the same tool as in FIG. 1, but with a self-sharpening feature added.

FIG. 3 is essentially the same tool as in FIG. 1, but with elongated handles.

FIG. 4 is essentially the same tool as in FIG. 2, but with elongated handles.

FIG. 5 shows a tool with the sharpening mechanism shown in FIG. 1 and FIG. 3, and has the addition of a compound lever.

FIG. 6 is the same tool as in FIG. 5, but with a self-sharpening feature added.

FIG. 7 shows a tool with the sharpening mechanism shown in FIG. 1, FIG. 3, and FIG. 5.

FIG. 8 is the same tool as in FIG. 7, but with a self-sharpening mechanism added.

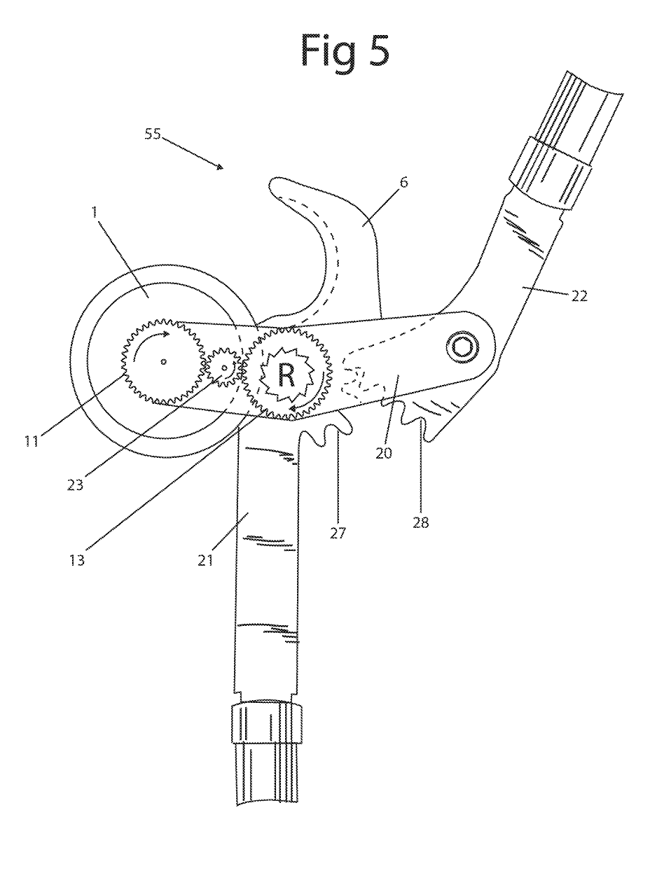

Reference Numerals

| | |
|---|---|
| 1 | disc |
| 2 | beveled edge |
| 3 | sharp edge |
| 4 | disc member |
| 5 | jaw member |
| 6 | jaw |
| 7 | hub |
| 8 | jaw handle |
| 9 | disc handle |
| 10 | sharpening mechanism |
| 11 | disc gear |
| 12 | center of disc |
| 13 | ratchet gear |
| 14 | spring |
| 15 | sharpening element housing |
| 16 | bore |
| 17 | sharpening element |
| 18 | spring washer |
| 19 | threaded plug |
| 20 | disc member in FIG. 5 & 6 |
| 21 | jaw member with teeth |
| 22 | disc member handle with teeth |
| 23 | intermediate gear |
| 24 | disc member plate |
| 25 | planar face of sharpening element |
| 26 | elongated handle |
| 27 | teeth on handle 22 |
| 28 | teeth on jaw member 21 |
| 29 | top plate |
| 30 | hollow pole |
| 31 | compound lever mechanism |
| 32 | intermediate gear |
| 33 | disc assembly |
| 34 | opposing jaw member |
| 35 | cable |
| 36 | top plate |
| 37 | bottom plate |
| 38 | pulley |
| 39 | compression spring |
| R | ratchet mechanism |

### DESCRIPTION/OPERATION

Each of the eight embodiments of my cutting tool include a ratchet mechanism R. Ratchet mechanism R includes a ratchet gear 13. Some ratchet mechanisms work only one direction of rotation or the other. Others are reversible. Either of these three possibilities can be incorporated with any of the tools shown herein. If the ratchet mechanism R engages during the cutting process, there is a simultaneous cutting and slicing, as disc 1 rotates. Conversely, if the ratchet mechanism engages after the cutting, in any of these embodiments, disc 1 does not rotate during the cutting process. Disc 1 rotates, and is sharpened as the jaws of the tool in each embodiment open.

### Description of Tool 51

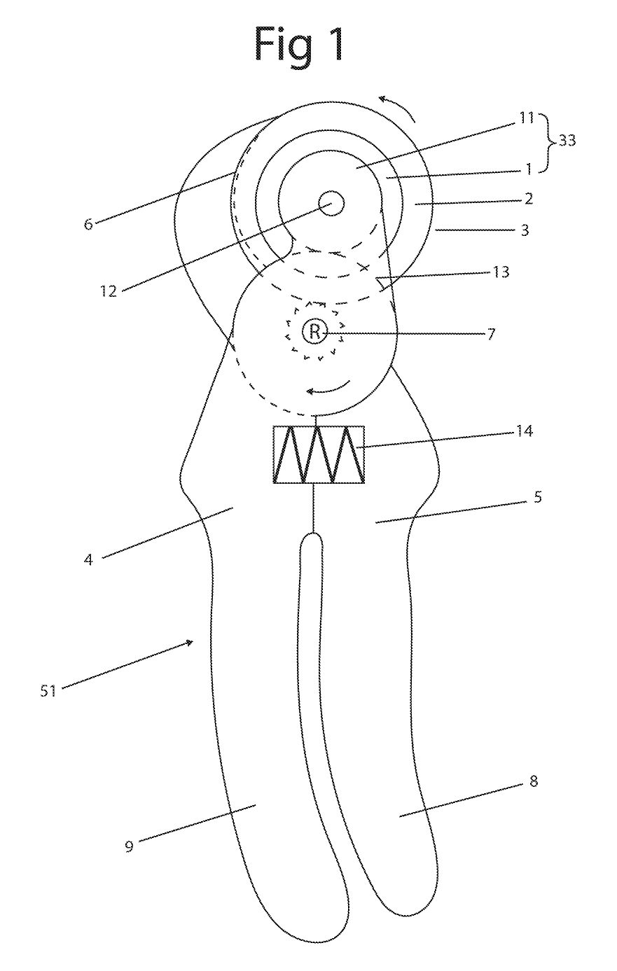

FIG. 1 shows a tool 51 as specified in claim 5. A cutting disc 1 has a disc gear 11 immovably affixed to its upper surface. Disc 1 and disc gear 11 are concentric and are referred to collectively as disc assembly 33. Disc assembly 33 is pivotally mounted on disc member 4. Disc 1 has a beveled edge 2. This results in a sharp edge 3 around the entire circumference of disc 1. As shown in FIG. 1, disc 1 is underneath disc member 4 and above opposing jaw member 5. The non-beveled side of disc 1 is generally coplanar with the planar portion of cutting jaw 6 that engages with disc 1. Jaw 6 may or may not be sharp. Disc 1 and jaw 6 are shown in the closed position. Disc member 4 and opposing jaw member 5 are pivotally connected at hub 7. Hub 7 is the center of ratchet mechanism R and ratchet gear 13. Ratchet gear 13 engages with disc gear 11. A compression spring 14 is located between the two handles and is compressed when the handles are closed. Handle 9 is an extension of disc member 4. Handle 8 is an extension of jaw member 5.

### Operation of Tool 51

During the operation of tool 51, as shown in FIG. 1, jaw member handle 8 and disc member handle 9 are pushed apart by spring 14. This creates an opening between the disc 1 and jaw 6. The object to be cut is placed in this opening. The pressing together of these two handles causes disc 1 to engage jaw 6. This motion results in the cutting of the object placed in the opening. Furthermore, this pressing together of the handles causes the ratchet mechanism R to force the rotation of ratchet gear 13 centered at hub 7. In turn, the rotation of ratchet gear 13 causes the rotation of disc assembly 33. The repetitive pressing together of these handles therefore results in the continuous rotation of disc 1. The cutting process is two-fold. The pressure between the disc 1 and the jaw 6 results in a cutting force. The rotation of disc 1 results in a slicing action. Disc 1 can be easily sharpened as follows: remove disc 1 from the tool in FIG. 1. Attach disc 1 near the end of a shaft that can be mechanically rotated. Rotate the shaft while holding a sharpening stone or file, flush with the beveled edge 2. When sharp, reattach disc 1 to the tool.

### Description of Tool 52

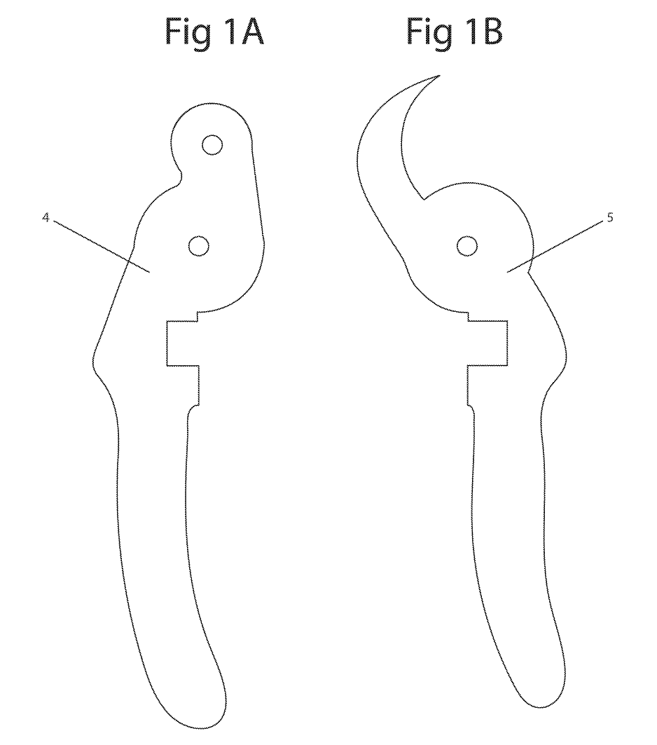

FIG. 2 shows a tool 52 that has all of the features of tool 51 plus the addition of a sharpening mechanism 10. This feature is specified in claim 2. A sharpening element housing 15 is attached to disc member 4. A bore 16 in housing 15 is positioned so that it can accommodate a sharpening element 17 in a position where a planar face 25 of element 17 rests against beveled edge 2 of disc 1. For optimal effect, this element 17 should span, radially, the entire width of beveled edge 2. A spring washer 18 rests on the surface of element 17 that is opposite to beveled edge 2. A threaded plug 19 holds element 17 and washer 18 in place. These elements 15, 16, 17, 18, and 19 are referred to collectively as sharpening mechanism 10.

### Operation of Tool 52

Tool 52 is operated in the same way as tool 51. But with tool 52, as disc 1 continuously rotates, beveled edge 2 slides across planar face 25 of sharpening element 17. Therefore disc 1 is continuously sharpened. Plug 19 can be tightened to increase the pressure of element 17 onto beveled edge 2. Conversely, plug 19 can be loosened to decrease the pressure of element 17 onto beveled edge 2.

### Description of Tool 53

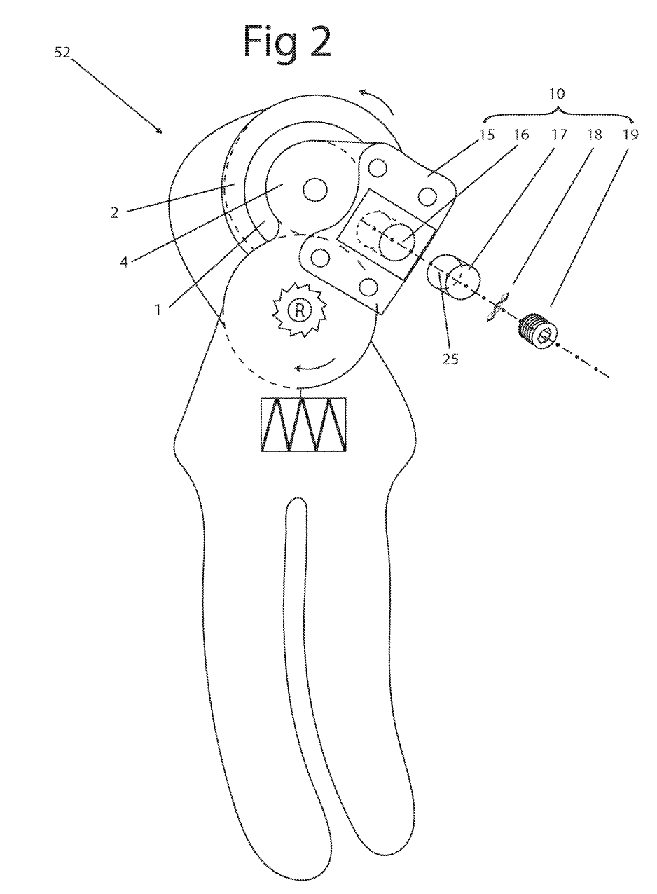

FIG. 3 shows a tool 53 as specified in claim 7. Tool 53 has the same cutting mechanism as tool 55. Tool 53 has elongated handles 26 to provide increased leverage. This type of tool typically requires the use of two hands. A flexible bumper 21 is located between handles 26 where they would otherwise touch.

### Description of Tool 54

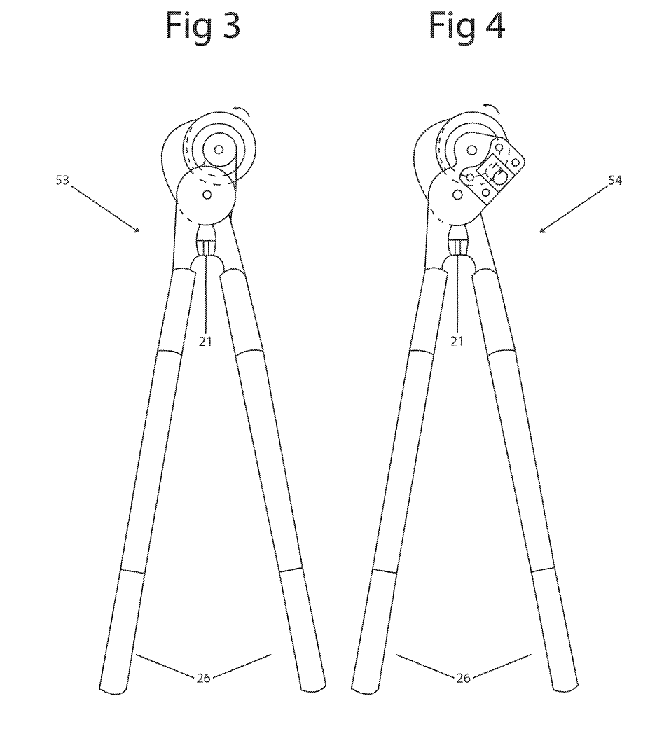

FIG. 4 shows a tool 54 as specified in claim 4. Tool 54 has all of the features of tool 53 in FIG. 3 plus the addition of sharpening mechanism 10.

### Operation of Tools 53 and 54

Tool 53 in FIG. 3 and tool 54 in FIG. 4 operate in the same way. Each hand of the operator grasps a handle 26. Handles 26 are pulled away from each other so as to create an opening between disc 1 and jaw 6. The tool is positioned so that the object to be cut is within this opening. Handles 26 are then pushed together. This causes disc 1 to engage with jaw 6 sliding across it to make a cut. Simultaneously, ratchet mechanism R forces ratchet gear 13 to rotate. This, in turn, causes disc assembly 33 to rotate. Therefore disc 1 rotates and slices while it cuts.

### Description of Tool 55

FIG. 5 shows a tool 55 as specified in claim 10. This is an adaptation of my cutting tool to a pruning tool with a compound lever mechanism 31. A disc member 20 is a boomerang-shaped plate. Ratchet mechanism R includes a ratchet gear 13 that engages with an intermediate gear 23. Intermediate gear 23 engages with disc gear 11. Disc member 20 is pivotally connected to a jaw member 21 at the center of ratchet R. Jaw member 21 has teeth 28. A disc member handle 22 with teeth 27 is pivotally connected to disc member 20.

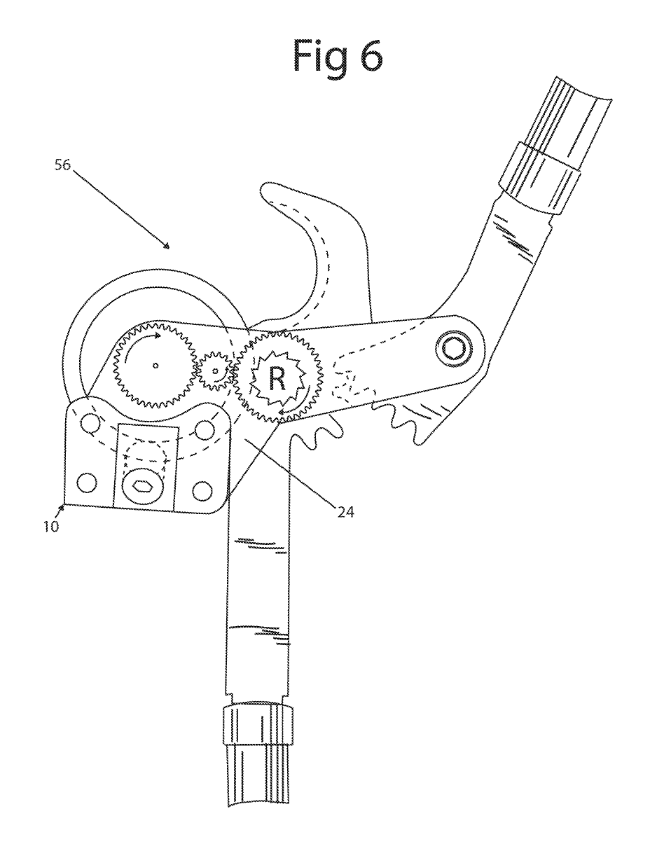

Description of Tool 56 FIG. 6 shows a tool 56 which is the same as tool 55 with the addition of sharpening mechanism 10. A disc member plate 24 is an extended version of plate 20 in FIG. 2. Plate 24 is shaped so that it can accommodate sharpening mechanism 10.

### Operation of Tools 55 and 56

Tool 55 in FIG. 5 operates the same as tools 53 and 54. As a jaw member handle 21 and a disc member handle 22 are pressed together, teeth 27 on disc member handle 22 mesh with teeth 28 on jaw member handle 21. This provides leverage as disc 1 engages with jaw 6 for the purpose of cutting. As the handle 21 and handle 22 are pressed together, ratchet R forces ratchet gear 13 to rotate. This action causes intermediate gear 23 to rotate. This, in turn, causes disc assembly 33 to rotate. Tool 56 in FIG. 6 operates the same as tool 55 in FIG. 5. The addition of sharpening mechanism 10 causes disc 1 to be sharpened as it rotates.

### Description of Tool 57

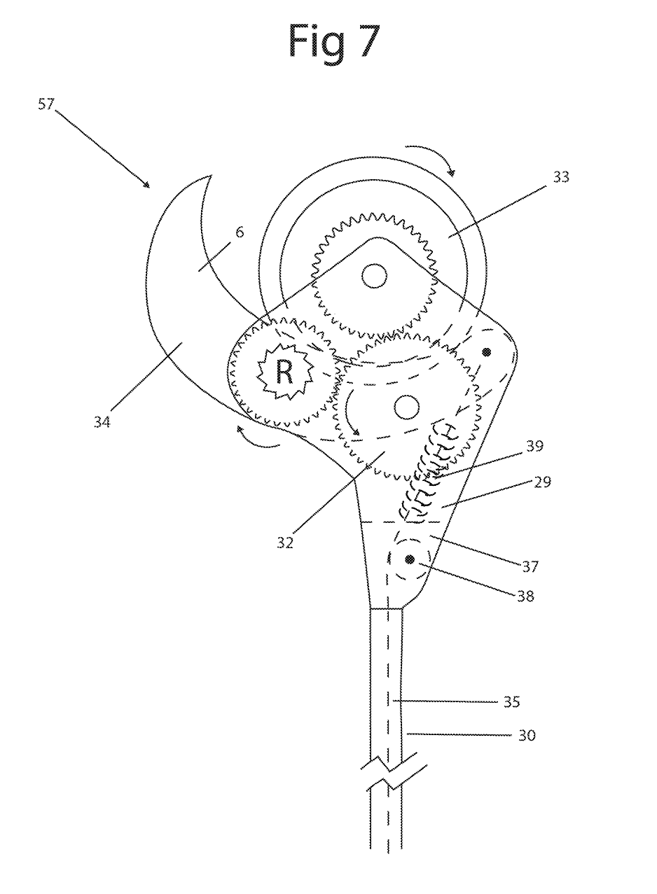

FIG. 7 shows a tool 57 where disc assembly 33 is mounted on one end of a hollow pole 30. A top plate 29 is affixed to one end of hollow pole 30. Ratchet mechanism R is mounted to the bottom of top plate 29. Ratchet mechanism R includes a ratchet gear 31 that is flush to the bottom of top plate 29. An intermediate gear 32 is attached to the bottom of top plate 29 and engages with ratchet gear 31. Disc gear assembly 33 is likewise mounted to the bottom of top plate 29. Disc gear 11 is flush with the bottom of top plate 29 and engages with intermediate gear 32. Ratchet mechanism R is sandwiched between top plate 29 and opposing jaw member 34. Ratchet mechanism R is affixed to the opposing jaw member 34. A cable 35 is attached to opposing jaw member 34 at the end opposite to jaw 6. A bottom plate 37 is parallel to top plate 29 and is attached to hollow pole 30. A pulley 38 is sandwiched between top plate 29 and bottom plate 37. Cable 35 goes through a compression spring 39, over pulley 38, and into hollow pole 30.

### Description of Tool 58

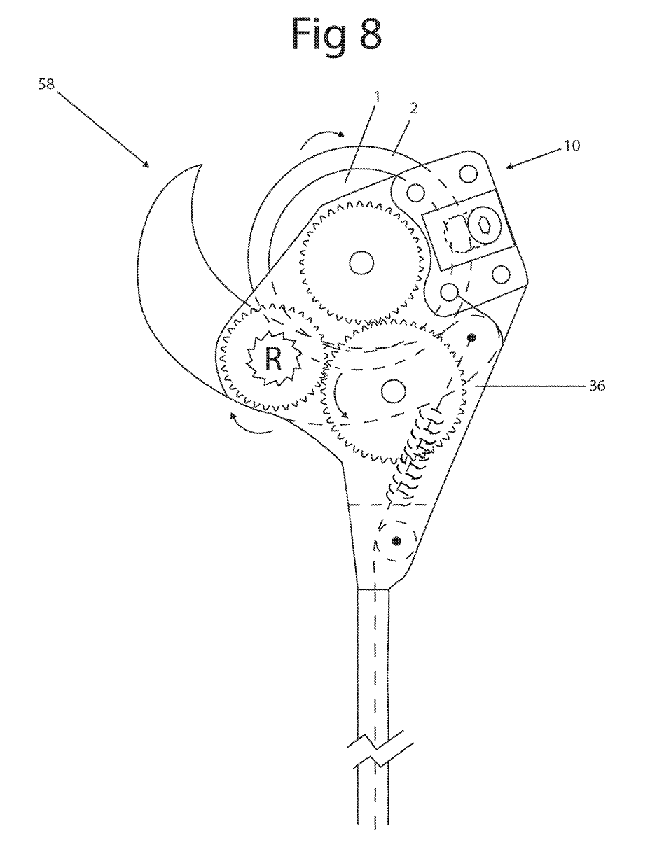

FIG. 8 shows a tool 58 that has all of the elements of tool 57. It also has the additional feature of sharpening mechanism 10. A top plate 36 is larger than top plate 29 in FIG. 7 in order to accommodate sharpening mechanism 10.

### Operation of Tools 57 and 58

The cutting process is identical for tool 57 in FIG. 7 and tool 58 in FIG. 8. Cable 35 is pulled from the end of hollow pole 30 opposite to cutting apparatus 28. This causes opposing jaw member 34 to rotate around ratchet mechanism R. This rotation causes intermediate gear 32 to rotate. This, in turn, causes assembly 33 to rotate. Simultaneously, opposing jaw member 34 engages disc 1 resulting in a cut. The tool in FIG. 8 has the addition of sharpening mechanism 10. Therefore as disc 1 rotates, beveled edge 2 of disc 1 is sharpened.

### Conclusions, Ramifications, and Scope

My cutting tool, as specified in claim 1 and shown in FIGS. 5, 7, 10, and 13 offers several advantages over the prior art. The cutting disc has a significantly longer surface than do most conventional cutting tools. Because the disc continually rotates as the tool is used, the entire circumference is used for cutting. Therefore, the tool requires sharpening less often. Also, the sharpening process is much easier with a circular disc, as was previously discussed. My tool specifically has advantages over the tool in U.S. Pat. No. 2,567,051. First, the entire circumference of the disc in my tool is used. This results in more usage before sharpening is needed. Second, it is not necessary with my tool, to remove the disc, rotate it, and re-mount it.

My cutting tool, as specified in claim 2 and shown in FIGS. 6, 8, 12, and 14 has the further advantage of the self-sharpening feature. I have found no prior art relevant to this feature. There are many variations of the tools shown here, and some that are not, that would fall within the reach of the claims. Tools such as toppers, pruners, wire cutters, tin snips, scissors, and secateurs, for example, could all use the mechanisms specified in claim 1 and claim 2.

There are also obvious variations of the tools shown here. The sharpening element housing could be built into the disc member. One or more Belville washers could replace the spring washer. A safety guard could protect the disc. Cover plates could be added to encase the gears. A source of power, other than manual, could be incorporated with any of these tools.

The intermediate gear shown in FIGS. 5, 6, 7, and 8 is not required for the function of these tools. It is shown here to demonstrate that there are different options for gear sizes. If this gear was omitted, the ratchet gear and/or the disc gear would need to be larger in diameter. This would allow the ratchet gear to engage directly with the disc gear.

Thus the scope of the embodiments should be determined by the appended claims and their legal equivalents, rather than by the examples given.

1. A cutting tool comprising:
a. a circular cutting disc, the disc being generally planar on one side and having a beveled edge on the other side whereby there is a sharp cutting edge around the entire circumference of said disc,
b. a disc assembly comprised of said disc and a disc gear concentrically and immovably mounted on the surface of said disc having said beveled edge,
c. said disc assembly being pivotally mounted on a disc member, such that said gear is adjacent to a face of said disc member,
d. an opposing jaw member having a jaw, said jaw having a generally planar portion that is coplanar with said planar portion of said disc,
e. a means of pivotally connecting said disc member and said jaw member whereby said disc and said jaw can be engaged,
f. a means of engaging said disc with said jaw,
g. and a means of continuously rotating said disc in its plane and around its center.

2. The tool in claim 1 further comprising a sharpening mechanism comprised of
a. a sharpening element with a planar face,
b. a means of engaging said planar face of said sharpening element with said beveled edge of said disc,
c. and a means of applying pressure to said sharpening element whereby said planar face of said sharpening element presses against said beveled edge of said disc.

3. The tool in claim 1 wherein the means for rotating said disc in 1 g includes a ratchet mechanism, said ratchet mechanism having a ratchet gear, said ratchet gear engaging with said disc gear.

4. The tool in claim 2 wherein the means for rotating said disc in 1 g includes a ratchet mechanism, said ratchet mechanism having a ratchet gear, said ratchet gear engaging with said disc gear.

5. The tool in claim 3 wherein said disc member includes a handle, said handle being sized so as to fit into the hand of an adult, and said handle extending in a direction generally opposite to said disc, and said jaw member having a handle similarly sized to said disc member handle and said jaw member handle extending in a direction generally opposite to said jaw whereby said handles provide said means for engaging in claim 1 f.

6. The tool in claim 4 with said handles in claim 5.

7. The tool in claim 3 wherein said disc member includes an elongated handle and said elongated handle extending in a direction generally opposite to said disc; and said jaw member having an elongated handle extending in a direction generally opposite to said jaw, whereby said handles provide said means for engaging in claim 1 f.

8. The tool in claim 4 with said elongated handles in claim 7.

9. The tool in claim 3 wherein the means of connecting in 1 e includes a means of leveraging the cutting force.

10. The tool in claim 9 wherein said means of leveraging is a compound lever.

11. The tool in claim 4 wherein the means of connecting in 1 e includes a means of leveraging the cutting force.

12. The tool in claim 11 wherein said means of leveraging is a compound lever.

13. The tool in claim 1 wherein
a. said cutting disc member in claim 1 b is a plate, said plate being mounted on an elongated hollow pole and said plate being the means of connecting said disc member and said jaw member in claim 1 d;
b. opposing jaw member in claim 1 c being pivotally connected to said plate at the center of a ratchet mechanism,
c. the end of said opposing jaw member opposite to the cutting portion of said jaw being attached to a pulling device, the device including an element selected from the group comprised of a rope, a chain, a cable, a handle,
d. said element entering said hollow pole where the pole is attached to said plate,
e. said ratchet mechanism having a ratchet gear that engages with an intermediate gear, said intermediate gear engaging with a disc gear, said disc gear being pivotally connected to said disc.

14. The tool in claim 13 with said sharpening mechanism in claim 2.

15. The tools in claim 10, claim 12, claim 13, and claim 14 wherein the means of pivotally connecting in 1 e and the means of engaging in 1 f and the means of continuously rotating in 1 g includes a ratchet mechanism having a ratchet gear, said ratchet gear engaging with said intermediate gear, and said intermediate gear engaging with said disc gear.

16. A method for cutting using the tool in claim 5 and an identical method for using the tool in claim 6 comprising:
a. holding said tool with both handles in one hand,
b. relaxing the grip in said hand whereby a spring urges said handles apart, thereby creating an opening between a jaw and a disc,
c. positioning said opening so that the object to be cut is confined in said opening between said disc and said jaw,
d. urging said handles together by forcefully closing said hand thereby cutting said object in said opening.

17. An identical method for using the tools in claim 7, claim 8, claim 10, and claim 12 comprising:
a. the grasping in each hand of one of the two elongated handles,
b. the urging apart of said handles by moving said hands in opposite directions, whereby an opening is made between a jaw and a disc,
c. the positioning of said opening so that the object to be cut is confined in said opening,
d. the urging together of said handles by forcing said hands towards each other thereby cutting said object in said opening.

18. An identical method for using the tools in claim 13 and claim 14 comprising:
a. grasping of said tool in one hand,
b. relaxing the tension on a pulling device with the other hand whereby a compressed spring urges a jaw and a disc away from each other thereby creating an opening,
c. positioning said opening so that the object to be cut is in said opening,
d. pulling on said pulling device whereby said jaw and said disc are engaged thereby cutting said object in said opening.
